(19) United States
(12) Patent Application Publication
(10) Pub. No.: US 2009/0134733 A1
(43) Pub. Date: May 28, 2009

(54) Vibration generating stepping motor

(75) Inventors: Masaaki Matsubara, Tottori (JP); Kazuaki Sato, Tottori (JP); Mikio Umehara, Tottori (JP); Toshiaki Tsuzaki, Tottori (JP)

Correspondence Address: FOLEY AND LARDNER LLP;SUITE 500, 3000 K STREET NW, WASHINGTON, DC, 20007, US

(73) Assignee: Minebea-Matsushita Motor Corporation

(21) Appl. No.: 11/666,490

(22) PCT Filed: Oct. 31, 2006
(86) PCT No.: PCT/JP06/21775

§ 371 Date: Apr. 27, 2007

(30) Foreign Application Priority Data
Nov. 18, 2005 (JP) 2005-333497

(51) Int. Cl. H02K 21/14

(52) U.S. Cl. 310/156.64

(57) ABSTRACT

Provided is a vibration generating stepping motor, which is ensured for holding a stop position by increasing a detent torque. The pole teeth of one stator yoke of a single-phase stator yoke assembly includes two kinds of pole teeth made different in the outermost side faces in the radial direction, and the pole teeth of the other stator yoke are comprised of two kinds of pole teeth made different in the outermost side faces in the radial direction. The pole teeth of one kind of the aforementioned individual stator yokes are made to have the same shape. The pole teeth of the remaining two kinds not given the same shape are combined and arranged to increase the detent torque.

### TECHNICAL FIELD

The present invention relates to a vibration generating stepping motor, which is ensured for holding a stop position by increasing a detent torque and, more particularly, to a PM single-phase type stepping motor.

### BACKGROUND ART

Stepping motors are heavily used, because they are simple in configuration and can be subjected to an open control so that a control circuit can be simply configured. A PM stepping motor using a permanent magnet is especially heavily used because it is inexpensive. These stepping motors require a precise stop position control for a normal start. In the using case for a stop position control of high precision, a device is made to reduce its detent torque because it makes a load at the time of rotating.

However, in case a load is heavy, e.g., in case a vibration generating stepping motor is loaded with a weight, it is difficult to stop the stepping motor precisely at its stop position when it is not excited. Thus, there have been proposed techniques (as referred to Patent Documents 1 to 3) for increasing the detent torque at the unexcitation time thereby to stop the load reliably.

According to the disclosure of the following technique described in Patent Document 1, two sets of vertical stator yokes are disposed to face a permanent magnet of a rotor. Pole teeth comprising the stator yokes are made into two kinds of wide and narrow pole teeth, and are arranged alternately in the rotating direction. The torque generating patterns in the individual phases at the unexcitation time are varied to increase the detent torque. According to this technique, however, the imbalance states of the torques in the individual phases are uncertain, and a constant detent torque cannot be retained in the manufacturing procedure thereby to raise an issue that products cannot be attained as expected.

The technique of the following Patent Document 2 is an improvement on the aforementioned Patent Document 1. Two sets of vertical stator yokes are disposed to face permanent magnets disposed in a rotor. In one of the two sets of stator yokes, the pole teeth are divided into two kinds having small and large widths. These pole teeth of the two kinds are arranged alternately in the rotating direction. In a cap-shaped case, the sum of areas of magnetic poles of the stator yokes on the bottom side and the sum of areas of magnetic poles of the stator yokes on the front side, i.e., the open side of the cap-shaped case, are set different from each other.

According to the above configuration, torque curve between each stator yoke group and the permanent magnet disposed in the rotor varies so that the torques are added in the procedure for synthesizing the two torques. As a result, it is possible to retain a necessary detent torque.

However, the techniques, as described in the aforementioned Patent Documents 1 and 2, are intended for pole teeth in a two-phase stator yoke assembly, but neither disclose nor suggest an application to pole teeth in a single-phase stator yoke assembly. The detent torque itself is generated by the combination of the pole teeth in the two-phase stator yoke assembly, so that it cannot be applied as it is to the pole teeth in the single-phase stator yoke assembly. No description is made on relations among the widths of the pole teeth, the magnitude of the detent torque and the stop position retention so that the magnitude of the detent torque and the degree of the stop position retention are unknown. Especially according to the technique of the following Patent Document 2, as shown in FIG. 4 thereof, there is disclosed a configuration, in which narrow pole teeth and a case are required and in which a path for a magnetic flux φb to transmit through the narrow pole teeth and the case has to be formed. It is, therefore, thought that the areas of the magnetic poles, as named by the technique described in the following Patent Document 2, are the result of adjustment of the width of the magnetic poles, but that the height (or the axial length) of the magnetic poles is not the target of the adjustment for the conveniences of using the case as the magnetic path. It is, therefore, indefinite whether or not the technique can be applied to the vibration generating stepping motor loaded with the eccentric weight.

According to the technique described in the following Patent Document 3, a rotor is provided with magnetic poles of permanent magnets magnetized in an axial direction. The two-phase stator yokes are individually provided with pole teeth. Of the pole teeth of the two groups combined, the pole teeth of one stator yoke are made to have volumes different from those of the other stator yoke. This constitution having different volumes is made by means for varying the thickness of the pole teeth in a radial direction, as taken from the axis, or areas (or areas of arcuate faces) of the pole teeth on the outermost side faces in the radial direction.

Patent Document 1: JP-A-60-043059

Patent Document 2: JP-A-06-078513

Patent Document 3: JP-A-09-308214

### DISCLOSURE OF THE INVENTION

### Problems to be Solved by the Invention

The technique, as described in Patent Document 3, for changing the thickness of the pole teeth to increase the detent torque has the following issue. The rotating shaft is borne by a bearing, and a play is given between the rotating shaft and the bearing so as to reduce their contact resistance. At the time of rotating, therefore, the rotating shaft finely deflects on its axial center so that an outer side face of the rotor radially deflects and vibrates. Even if, therefore, the thickness of the pole teeth (i.e., the radial thickness from the axial center) is made different, as described above, it is difficult to reflect the thickness size correctly. Therefore, it is difficult and impractical to set the size and the occurrence position (or the angular position) of the detent torque precisely.

Moreover, the technique for changing the area of the aforementioned pole teeth to enlarge the detent torque is thought to adopt the means for varying the thickness and the area of the pole teeth. The pole teeth, as shown in the aforementioned Patent Document 3, are formed to make the width of the shaft rotating direction narrower than that of the other ordinary pole teeth without changing the inclination of the sides but with the axial height being equal to that of the other common pole teeth. On the characteristics, the description has been made such that the magnetic flux density characteristics are similar between the case, in which the thickness of the pole teeth is varied, and the case, in which the area of the pole teeth is varied.

The magnetic flux density characteristics of the case, in which the thickness of the pole teeth is varied, are those under the condition, in which the axial height of the corresponding pole teeth is set equal to that of the remaining common pole teeth. On the other hand, the magnetic flux density characteristics of the case of the aforementioned Patent Document 3, in which the area of the pole teeth is varied, are thought to be the characteristics under the conditions, in which the axial height of the corresponding pole teeth is set equal to that of the remaining common pole teeth but, in which only the width is narrowed to lower the magnetic flux density characteristics. If the shape of the corresponding magnetic poles is varied together with the axial height from that of the other common pole teeth, the magnetic poles of the rotor are so set that the magnetic flux transmits through the face in the rotating direction. As a result, no magnetic flux transmits through the space between the pole teeth of one stator yoke and the flat face of the other stator yoke facing the former. The magnetic flux, as might otherwise transmit through that space, is largely bent so that the magnetic resistance is drastically increased. As a result, the magnetic flux density is drastically decreased. These magnetic flux characteristics are thought not to be, as shown. However, the shown magnetic flux density characteristics are those of the two-phase stator yoke but neither disclose nor suggest the single-phase characteristics.

As a result, the mere difference, if any, in the area of the pole teeth cannot be sufficient for the specification, which needs another condition from the viewpoint and effect to increase the detent torque. In this respect, Patent Document 3 describes the technical desires but dos not disclose the solving means to a necessary extent.

Therefore, the technique of Patent Document 3 presents the two-phase pole teeth for a target, but neither discloses nor suggests the application of the case of the single-phase pole teeth. The detent torque is generated by combining the two-phase pole teeth so that the technique cannot be applied as it is to the stepping motor having the single-phase pole teeth. Moreover, no description is made on the cause-and-effect relation between the thickness or area of the pole teeth and the detent torque itself and on the relation between the magnitude of the detent torque and the holding of the stop position. It is indefinite how high the detent torque is and how much the stop position is held. It is especially indefinite whether or not the technique can be applied to the vibration generating stepping motor loaded with the eccentric weight.

In view of the aforementioned issues, an object of the invention is to provide a vibration generating stepping motor, which is ensured for holding a stop position by increasing a detent torque.

### Means for Solving the Problems

A vibration generating stepping motor of the invention makes height, width and area of pole teeth of a stator yoke ununiform so as to stabilize the stop position at the unexcitation time. With this configuration, the detent torque is increased to stabilize the stop position irrespective of the load.

A vibration generating stepping motor is specified in the following.
(1) A vibration generating stepping motor is characterized: in that pole teeth of one stator yoke (i.e., a first stator yoke) of a single-phase stator yoke assembly are two kinds of pole teeth (i.e., first and second pole teeth) having areas of outermost side faces different in a radial direction of the stepping motor; in that pole teeth of the other stator yoke (i.e., the second stator yoke) are two kinds of pole teeth (i.e., first and second pole teeth) having areas of the outermost side faces different in the radial direction; in that the pole teeth (i.e., the first pole teeth) of one kind of the individual stator yokes are given an identical shape; in that the pole teeth of the remaining two kinds (i.e., the second and third pole teeth) having the different shapes are combined and so arranged while being shifted from hold positions (i.e., while the stop position of the rotor at the time when the coil is not excited being displaced from the stop position at the time when the coil is excited) as to increase a detent torque of the stepping motor.
(2) A vibration generating stepping motor as set forth in the aforementioned (1) is characterized in that the area is set by varying at least one of a height in an axial direction and a width in the rotating direction of the pole teeth.
(3) A vibration generating stepping motor as set forth in the aforementioned (1) or (2) is characterized in that the pole teeth on the outermost side faces in the radial direction are formed into a trapezoidal shape.
(4) A vibration generating stepping motor as set forth in the aforementioned (3) is characterized in that the inclination angle of an oblique side in the trapezoidal shapes of all the pole teeth are made equal.
(5) A vibration generating stepping motor as set forth in any one of the aforementioned (1) to (4) is characterized in that the pole teeth of the remaining two kinds not given the identical shape are provided in combination by one or more arbitrary n-pairs thereof. Here, the number n is (the number of the total pole tooth—the number of the pole tooth of the same configuration)/2.
(6) A vibration generating stepping motor as set forth in the aforementioned (1) is characterized: in that the first and second stator yokes are provided by combining the trapezoidal standard pole teeth (i.e., the first pole teeth) having a height in the axial direction, a width in the rotating direction and an oblique side of an inclination angle, the trapezoidal wider pole teeth (i.e., either of the second or third pole teeth) as high in the axial direction as the standard pole teeth, wider in the rotating direction than the standard pole teeth and equal in the angle of inclination of the oblique side to the standard pole teeth, and the trapezoidal narrower and lower pole teeth (i.e., the other of the second or third pole teeth) lower in the axial direction than the standard pole teeth, narrower in the rotating direction than the standard pole teeth and equal in the angle of inclination of the oblique side to the standard pole teeth; and in that a single-phase stator yoke assembly is configured by causing the individual pole teeth to mesh in a comb shape with each other.
(7) A vibration generating stepping motor as set forth in any one of the aforementioned (1) to (6) is characterized: in that a rotor magnet is disposed on a rotor facing the single-phase stator yoke assembly, and in that the rotor magnet is a rotor magnet magnetized at different magnetic poles alternately in the rotating direction.
(8) A vibration generating stepping motor as set forth in any one of the aforementioned (1) to (7) is characterized in that the pole teeth of the same shape are arranged to have their centers conforming to switching positions of NS magnetic poles of the rotor magnet, and in that the second pole teeth of not the same shape are arranged to have their centers shifted from the switching positions of the NS magnetic poles by an arbitrary shift angle to increase the detent torque.

As a result, the pole teeth to face the rotor magnet are formed to have ununiform areas, and the magnetic attraction of the rotor magnet is configured to act strongly thereby to increase the detent torque. Alternatively, the detent torque can also be increased by making the widths of the magnetic poles ununiform in the rotating direction.
(9) A vibration generating stepping motor as set forth in the aforementioned (7) is characterized in that the ring magnet has a ring-shaped back yoke.
(10) A vibration generating stepping motor as set forth in the aforementioned (9) is characterized in that the back yoke has a recess within a remaining range excepting a range containing the switching positions of the NS magnetic poles of the rotor magnet and its vicinity.

In order to stabilize the stop position at the unexcitation time, the rotor magnet is provided with the back yoke to adjust the magnetization waveform so that the magnetic flux waveforms to transmit through the pole teeth are varied to increase the detent torque. Especially, it is preferred that the aforementioned magnetization waveforms are adjusted to the rectangular shape.

### Advantage of the Invention

A vibration generating stepping motor of the invention has the following advantage.

Pole teeth of three kinds having different areas are formed by varying their heights and widths. Of these, the pole teeth of one kind are adopted as those of the standard type, and are arranged as the standard type on individual stator yokes but for partially. The pole teeth of the two kinds having different areas other than those of the standard type are combined in pairs, and are so arranged with a displacement angle as to increase the detent torque.

As a result, the detent torque can be increased to stop the load precisely at a stable position, even if the load is a vibration generating weight having a large mass. Therefore, the start is ensured.

The detent torque can be increased by combining the pole teeth of the two kinds having the different areas other than the pole teeth of the standard type, in pairs. After all, by combining the pole teeth of the three kinds, the stator yoke assembly can attain the action and advantage to increase the desired detent torque.

In connection with the feeding time and the feeding current, moreover, the detent torque can be increased while keeping the hold torque, so that the start can be ensured without deteriorating the starting characteristics.

### BRIEF DESCRIPTION OF THE DRAWINGS

FIGS. 1(a) to 1(e) are configuration diagrams of a stator yoke assembly of the invention and its pole teeth.

FIGS. 2(a) to 2(d) are top plan views extending magnetic poles and pole teeth in a rotating direction in accordance with the invention.

FIG. 3 is a sectional view of a main portion of a stepping motor of the invention.

FIGS. 4(a) to 4(c) are configuration diagrams of an outer rotor type vibration generating stepping motor of the invention.

FIGS. 5(a) and 5(b) are explanatory diagrams of the detent torque characteristics of a vibration generating stepping motor of the invention.

FIGS. 6(a) to 6(f) are assembly diagrams for a magnet assembly of the invention.

FIGS. 7(a) to 7(f) are assembling diagrams of another embodiment of a back yoke of the invention.

### DESCRIPTION OF REFERENCE NUMERALS AND SIGNS

1 Vibration Generating Stepping Motor
2 Interface Substrate
3 Cover
3a Disc Portion
3b Cylindrical Portion
4 Rotor
5 Stator
6 Stator Yoke
6a first Stator Yoke
6b Second Stator Yoke
6c Third Stator Yoke (Center Yoke)
6d Opening
6e Cutout
6f Disk Portion
6g Cylindrical Portion
6h Pole teeth
7 Coil Bobbin
8 Stator Coil
9 Ring Magnet
10 Shaft
10a Radially Constricted Protrusion
11 Rotor Frame
11a Opening
11b Disk Portion
11c Cylindrical Portion
12 Bearing
13 Weight Portion
14, 14A Back Yoke
14a Magnetic Path Forming Portions
14c Recesses
15 Magnet Assembly
16 Metal

### BEST MODE FOR CARRYING OUT THE INVENTION

A vibration generating stepping motor of the invention has the following characteristics.
(1) It is known in the related art that the detent torque is dispersed in the rotating direction and restrained within a small value by so setting the intervals between the pole teeth configuring the stator yoke of the stepping motor as to contain the widths of plural kinds.

For the conditions to increase the detent torque, therefore, it is effective to form the pole teeth into the trapezoidal shape of the identical inclination thereby to set the intervals between the pole teeth to a constant width.

In the case of an embodiment, the inclinations of the trapezoidal shapes of the pole teeth are set identical.
(2) A stepping motor of the embodiment of the invention is of a permanent magnet type having a single-phase stator yoke assembly, and includes ten poles of magnets, and upper and lower yokes having ten pole teeth. In each stator yoke, therefore, the pole teeth are equidistantly arranged at an interval of 72 degrees (i.e., 360 degrees/5 teeth). According to the uniform arrangement position, generally speaking, the detent torque has tendencies to appear high within the range of the shift angle (Δθ) from 0 degrees to several degrees (Δθ1), but low within the range from the several degrees (Δθ1) to the angle (Δθ2), at which the adjoining teeth overlap. As the number of pole teeth increases, the entire range of the shift angle becomes accordingly narrower so that the angle range for the detent torque to increase has a tendency to become accordingly narrower. In the case of the embodiment, the shift angle is set at 6.5 degrees.
(3) For setting the interval between the pole teeth, it is effective to shift the positions (or angles), at which the pole teeth are formed, or to vary the areas of one or more pole teeth. The areas of the pole teeth mean the outermost side faces of the pole teeth in the radial direction (i.e., the circumferential faces of the radially outermost faces). It has been described in the aforementioned (2) that the positions having the pole teeth formed are shifted.

For the means for varying the areas of one or more pole teeth, on the other hand, the case of the embodiment is provided with two kinds of the shape, in which the pole teeth are varied in their heights in the axial (or shaft) direction. In the case of the lower profile pole teeth, the inclination of the oblique sides of the trapezoid are equalized to that of the higher profile pole teeth, as described hereinabove, so that the width of the lower profile pole teeth in the rotating direction is smaller than that of the higher profile pole teeth.

Accordingly, in order that the pole teeth (i.e., the standard pole teeth) of another standard shape (i.e., the shape of the most types (later-described)) may be positioned at the standard angular positions, that is, in order to compensate the smaller width of the lower profile pole teeth, the wider profile pole teeth wider than the standard shape in the rotating direction and as high as the standard shape are disposed at the positions which are shifted by the shift angle in the rotating direction from the standard position.

### (4) Pole Teeth:

(4-1) The pole teeth of one stator yoke of a single-phase stator yoke assembly includes two kinds of pole teeth having areas of the outermost side faces different in the radial direction. The pole teeth of the other stator yoke having areas of the outermost side faces are different in the radial direction. The pole teeth of one kind of the individual stator yokes are given an identical shape. The pole teeth of the remaining two kinds having the different shapes are combined and arranged to increase the detent torque.
(4-2) The area of the outermost side faces of the pole teeth in the radial direction is set by varying at least one of the height in the axial direction and the width in the rotating direction of the pole teeth.
(4-3) The outermost side faces of the pole teeth in the radial direction are formed into the trapezoidal shape.
(4-4) The inclination angles of the oblique sides in the trapezoidal shapes of all the pole teeth are made equal.
(4-5) The pole teeth of the remaining two kinds not given the identical shape are provided in combination by one or more arbitrary n-pairs thereof. Here, the number n is (the number of the total pole teeth—the number of the pole teeth of the same configuration)/2.
(4-6) The first and second stator yokes are provided by combining the trapezoidal standard pole teeth having a height in the axial direction, a width in the rotating direction and oblique sides of an inclination angle, the trapezoidal wider pole teeth as high in the axial direction as the standard pole teeth, wider in the rotating direction than the standard pole teeth and equal in the angles of inclination of their oblique sides to the standard pole teeth, and the trapezoidal narrower and lower profile pole teeth lower in the axial direction than the standard pole teeth, narrower in the rotating direction than the standard pole teeth and equal in the angles of inclination of their oblique sides to the standard pole teeth; and in that a single-phase stator yoke assembly is configured by causing the individual pole teeth to mesh in a comb shape with each other.
(4-7) The rotor magnet is disposed on a rotor facing the single-phase stator yoke assembly, and the rotor magnet is a ring magnet magnetized at different magnetic poles alternately in the rotating direction.

As a result, the pole teeth to face the rotor magnet are formed to have ununiform areas, and the magnetic attractions of the rotor magnet are configured to act strongly thereby to increase the detent torque. Alternatively, the detent torque can also be increased by making the widths of the magnetic poles ununiform in the rotating direction.
(4-8) The pole teeth of the same shape are arranged to have their centers conforming to the switching positions of the NS magnetic poles of the rotor magnet, and the second pole teeth of not the same configuration are arranged to have their centers shifted from the switching positions of the NS magnetic poles by an arbitrary shift angle to increase the detent torque.
(4-9) The ring magnet has ring-shaped back yoke.
(4-10) The back yoke has recesses within the remaining ranges excepting the ranges containing the switching positions of the NS magnetic poles of the rotor magnet and its vicinity.

In order to stabilize the stop position at the unexcitation time, the rotor magnet is provided with the back yoke to adjust the magnetization waveform so that the magnetic flux waveforms to transmit through the pole teeth are varied to increase the detent torque. Especially, it is preferred that the aforementioned magnetization waveforms are adjusted to the rectangular shape.

Here, the pole teeth of three kinds having different areas are formed by varying their heights and widths. Of these, the pole teeth of one kind are adopted as those of the standard type, and are arranged as the standard type on the individual stator yokes but for partially. The pole teeth of the two kinds having different areas other than those of the standard type are combined in pairs, and are so arranged with a shift angle as to increase the detent torque. Other than this embodiment, it is possible to use pole teeth of four or more kinds having different areas. In the case of the embodiment, moreover, the combination of the pole teeth of two kinds having different areas other than the pole teeth of the standard type is only one pair, but can also be two or more pairs. Specifically, the pole teeth of one or more arbitrary n pairs can be provided. Here, the number n is (the number of the total pole teeth—the number of the pole teeth of the same shape (or the standard pole teeth)/2.

The “standard pole teeth” are the pole teeth of the type which is most provided of the pole teeth of the later-described plural kinds. In the case of the embodiment, the type A is the standard polar tooth.

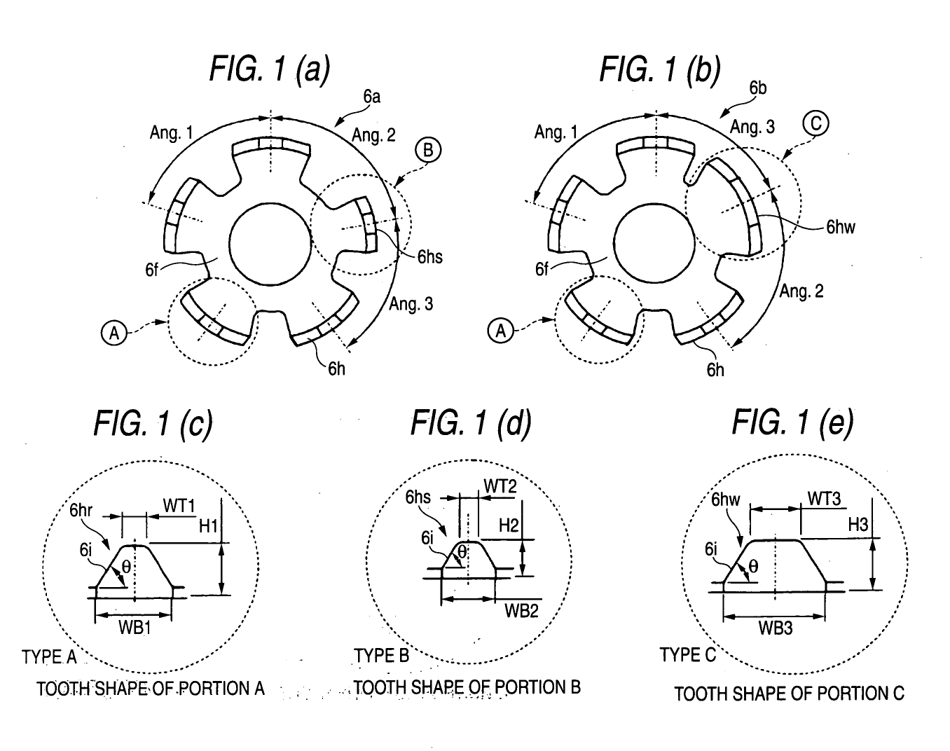

FIGS. 1(a) to 1(e) are configuration diagrams of a stator yoke assembly of the invention and its pole teeth.

FIG. 1(a) is a bottom view of a first stator yoke 6a; FIG. 1(b) is a bottom view of a second stator yoke 6b; FIG. 1(c) is a side elevation view of a standard pole tooth arranged at a uniform pitch; FIG. 1 (d) is a side elevation view of a pole tooth 6hs having a small width and a small height of the first stator yoke 6a; and FIG. 1(e) is a side elevation view of a pole tooth 6hw having a large width of the second stator yoke 6b.

The stator yoke assembly has one phase including the first stator yoke 6a and the second stator yoke 6b. In this embodiment, each stator yoke has five pole teeth.

The stator yoke assembly has a single phase including the second stator yoke 6b and the first stator yoke 6a. Here, a third stator yoke 6c has no pole tooth so that it is not incorporated into the stator yoke assembly.

The first stator yoke 6a has five pole teeth. Of these, the four pole teeth are pole teeth 6hr of a standard type A (which is exemplified by a trapezoidal shape having a wide portion WB1, a narrow portion WT1, a height H1 and an oblique side inclination of θ (degrees)), and are disposed at a uniform open angle (Ang.1) on the axis. The remaining pole tooth is the pole tooth 6hs of a type B (which is exemplified by a trapezoidal shape having a wide portion size WB2 (=0.7 WB1), a narrow portion WT2 (=0.87 Wt1), a height H2 (=0.7 H1) and an oblique side inclination of θ (degrees)), and has a center spaced by about 0.9 times (Ang.3) of a uniform pitch from the center of the pole tooth clockwise preceding in the top plan view and by about 1.1 times (Ang.2) of a counterclockwise uniform pitch from the center of the pole tooth clockwise trailing in the top plan view.

The second stator yoke 6b also has five pole teeth. Of these, the four pole teeth are the pole teeth 6hr of the standard type A (which is exemplified by a trapezoidal shape having the wide portion WB1, the narrow portion WT1, the height Hi and an oblique side inclination of θ (degrees)), and are disposed at a uniform open angle (Ang.1) on the axis. The remaining pole tooth is the pole tooth 6hw of a type C (which is exemplified by a trapezoidal shape having a wide portion size WB3 (=1.34 WB1), a narrow portion WT3 (=1.84 WT1), a height H3 (=1 H1) and an oblique side inclination of θ (degrees)), and has a center spaced by about 0.9 times (Ang.3) of a uniform pitch from the center of the pole tooth clockwise preceding in the top plan view and by about 1.1 times (Ang.2) of a counterclockwise uniform pitch from the center of the pole tooth clockwise trailing in the top plan view.

As the inclination of an oblique side 6i of pole tooth 6h is increased (or made steeper), the waveform indicating the change in the magnetic flux density can be formed from a gentle mountain shape into a generally rectangular shape so that a detent torque can be increased.

The pole teeth 6h have the type A as their standard type, and are disposed to have their centers aligned to the four of the five portions at the reference angles (i.e., the angles corresponding to the uniform pitch) in the individual stator yokes.

The remaining one pole tooth other than those of the type A of the first stator yoke 6a is so spaced by about 1.1 times of the uniform pitch from the position of the pole tooth of the standard type on one side and by about 0.9 times (as referred to FIG. 1(a) of the uniform pitch from the position of the pole tooth of the standard type on the other side as to have its center aligned with the pole tooth 6hs of the type B.

The remaining one pole tooth other than those of the type A of the second stator yoke 6b is so spaced by about 0.9 times of the uniform pitch from the position of the pole tooth of the standard type on one side and by about 1.1 times (as referred to FIG. 1(b)) of the uniform pitch from the position of the pole tooth of the standard type on the other side as to have its center aligned with the polar tooth 6hw of the type C.

The first stator yoke 6a and the second stator yoke 6b are combined to have their pole teeth 6h meshing with in a comb tooth shape. With respect to the centers of the standard pole teeth, the standard pole teeth of the second stator yoke 6b are displaced by 36 degrees in the rotating direction.

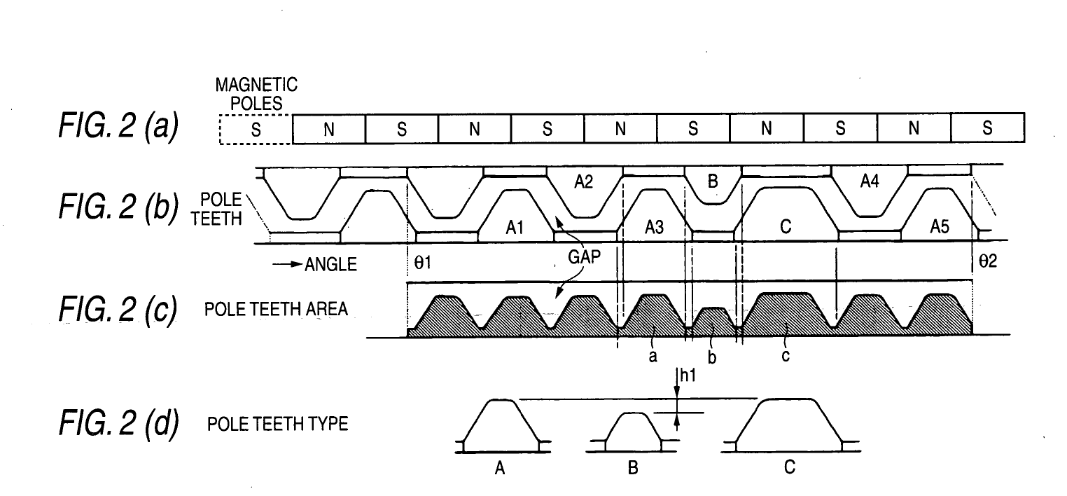

FIGS. 2(a) to 2(d) are top plan views extending the magnetic poles and the pole teeth of the rotating direction in accordance with the invention.

FIG. 2(a) is an extended view of the magnetic poles; FIG. 2(b) is a top plan extension of the stator yoke provided with pairs of upper and lower pole teeth; FIG. 2(c) is a diagram showing relations between the sums and the intervals of the magnetic pole areas; and FIG. 2(d) is structural diagram of different pole tooth types.

The pole teeth 6h are arranged at their positions, as shown in FIG. 2(b). The angular characteristics of the total areas of the pole teeth of the first stator yoke 6a and the second stator yoke 6b (i.e., the areas including those of the two pole teeth of the axial direction) are shown in FIG. 2(c). The angular characteristics of the total areas of standard pole teeth A1 to A4 of the type A are the same pole tooth area a. In the case the pole tooth type B is included on one side, a pole tooth area b is far smaller than that of the case of the type A, as shown in FIG. 2(c). Accordingly, the magnetic flux density is lowered, and the retention (or detent) torque is also lowered.

In the case the pole tooth type C is contained, on the contrary, a pole tooth area c is far larger than that of the case of the type A, as shown in FIG. 2(c). Accordingly, the magnetic flux density is raised, and the retention (or detect) torque is also increased.

Here is described the process for forming the magnetic path of the case, in which the pole teeth of the different heights, widths and areas thus far described.

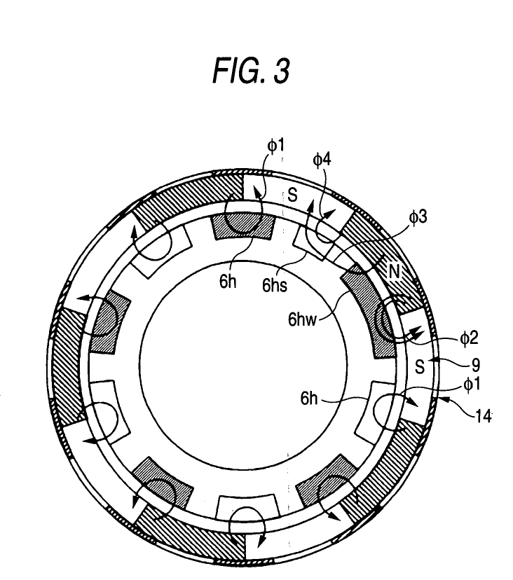

FIG. 3 is a sectional view of a main portion of the stepping motor.

The stepping motor of the embodiment is a permanent magnet type outer rotor stepping motor provided with a single-phase stator yoke assembly, and includes ten poles of ring magnet and ten pole teeth in the two upper and lower stator yokes.

On the rotor side, there is shown only the configuration, in which the ring magnet having different poles magnetized alternately in the rotating direction is disposed in a later-described ring-shaped back yoke, but a rotor frame is omitted. On the stator side, there is shown only pole teeth provided in the two upper and lower stator yokes.

FIG. 3 shows the state, in which the boundary between the different magnetic poles of the ring magnet is disposed at a substantially intermediate position of the length, as taken in the rotating direction, of the standard pole tooth 6hr of the type A.

In this state, a magnetic flux φ1 emanating from the N-pole transmits through the standard pole tooth 6hr of the type A, as shown, and returns to the adjoining S-pole.

A plurality of magnetic fluxes transmit through the pole tooth 6hw of the type C (as referred to FIG. 2) of FIG. 3. A first magnetic flux φ2 emanating from the N-pole transmits through the pole tooth 6hw of the type C, as shown, and returns to the adjoining S-pole. A second magnetic flux φ3 transmits through the pole tooth 6hw of the type C, as shown, and then through the pole tooth 6hs of the type B via the air gap, and returns to the adjoining S-pole. The magnetic path based on the magnetic flux φ3 has a high magnetic resistance in the air gap so that the magnetic flux density does not seriously fluctuate.

A magnetic flux φ4 emanating from the N-pole transmits the pole tooth 6hs of the type B, and returns to the S-pole on the other side. This magnetic flux φ4 is caused, by rotating ring magnet 9 slightly clockwise, to move its magnetic pole boundary to the outside of the pole tooth 6hs of the type B.

When the rotor is slightly rotated from a stable position of a high magnetic flux density of FIG. 3 thereby to rotate the ring magnet 9 clockwise, therefore, the magnetic flux φ4 disappears so that many magnetic paths of the standard pole teeth 6hr of the type A are deformed to lower the entire magnetic flux density.

When the pole tooth 6hs of the type B and the pole tooth 6hw of the type C are adjusted on their heights and widths to vary the area of the pole teeth, on the other hand, the detent torque can be changed for the following reasons.

As the ratio of S2/S1=K between the area (i.e., the area of the pole teeth magnetically facing the magnetic poles) S1 of the pole teeth and the area S2 of the magnetic poles (i.e., the magnetic poles of the permanent magnet) magnetically facing the pole teeth becomes higher, the magnetic flux density has a tendency to raise so that the detent torque is increased. It is thought that the ratio K is proportional to a shift angle Δθ.

On the basis of this, as seen in FIG. 2(c), the pole tooth area b is extremely reduced at the pole tooth 6hs of the type B. As a result, the detent torque is decreased at the pole tooth 6hs of the type B. The pole tooth area c at the pole tooth 6hw of the type C on the right side is extremely larger than that of the standard pole tooth 6hr of the type A. As a result, the detent torque is increased at the pole tooth 6hw of the type C.

From the description thus far made, the position of the pole tooth 6hs of the type B is passed to provide no stop position so that the stop never fails to occur at the position of the pole tooth 6hw of the type C. This raises the stop position precision.

An embodiment of the invention is described in detail with reference to the accompanying drawings.

### EMBODIMENT 1

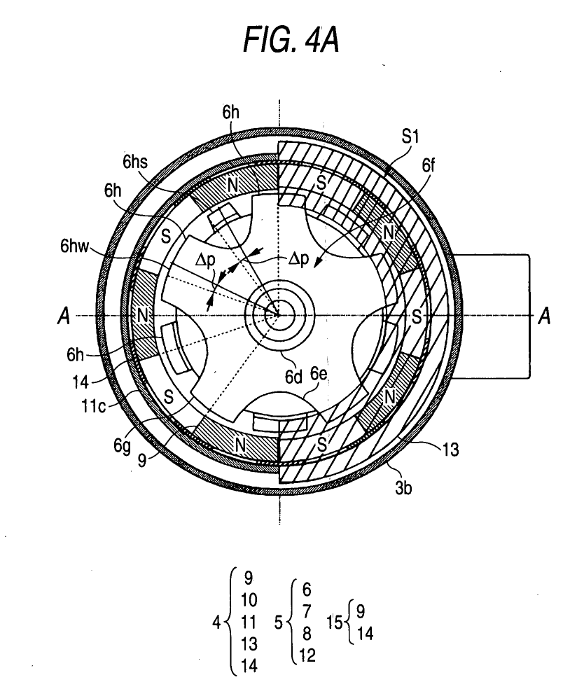

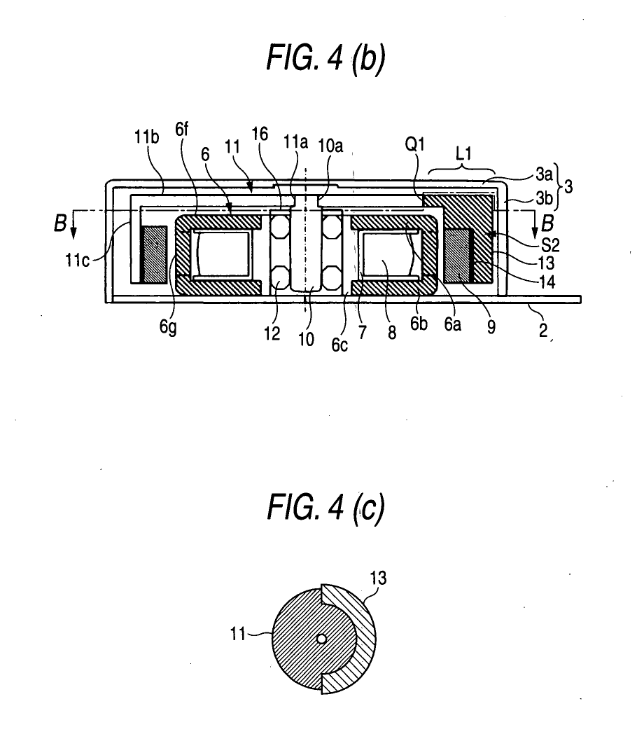

FIGS. 4(a) to 4(c) are configuration diagrams of an outer rotor type vibration generating stepping motor of the invention.

FIG. 4(a) is a section B-B of FIG. 4(b); FIG. 4(b) is a section A-A of FIG. 4(a); and FIG. 4(c) is a top plan view of the rotor frame.

An outer rotor type vibration generating stepping motor 1 includes an interface substrate 2, a cover 3, a rotor 4 and a stator 5.

The interface substrate 2 is structured by forming an insulating film on a metal plate and by forming thereon a necessary wiring (such as power feed line to a coil) and an opening (not shown) for fitting the protrusion (not shown) of the cover 3. On the interface substrate 2, there are fixed through an insulating film a second stator yoke 6b on the side of the interface substrate 2 and a center yoke 6c to become a third stator yoke of a stator yoke 6. The projection (not shown) of the end face of a cylindrical portion 3b of the cover 3 is fitted in the opening. They are soldered from the back face of the interface substrate 2. The control circuit, the power source and so on of the outside are connected with the wiring.

The stator 5 includes: a stator coil 8 wound on a coil bobbin 7; the stator yoke 6 including a first stator yoke 6a, the second stator yoke 6b and the center yoke 6c or the third stator yoke; and a bearing 12. A metal 16 is mounted on the bearing 12.

The stator yoke 6 is made of a magnetic material and includes a first stator yoke 6a and the second stator yoke 6b individually having pole teeth, and the center yoke 6c or the third stator yoke supporting those first stator yoke 6a and second stator yoke 6b and forming magnetic paths together with them. Here is omitted the description on the items having been described on the first stator yoke 6a and the second stator yoke 6a.

The first stator yoke 6a and the second stator yoke 6b are formed as a whole into a cup shape having an opening 6d and cutouts 6e, as shown in a top plan view in FIG. 4(a). Specifically, the opening 6d is formed in the center of a cup shape having a cylindrical portion 6g around a disk portion 6f, and the five substantially U-shaped cutouts 6e having the opening 6d are equidistantly formed in the open end from the cup-shaped cylindrical portion 6g to the disk portion 6f, so that pole teeth 6h are left between the substantially U-shaped cutouts 6e. The open ends of the substantially U-shaped cutouts 6e are set in the free ends of the cup-shaped cylindrical portion 6g. The substantially U-shaped cutouts 6e have their shapes determined as the result of forming the pole teeth 6h properly.

The first stator yoke 6a and the second stator yoke 6b thus formed are so vertically arranged that their pole teeth 6h may mesh in the comb tooth shape with each other. Between these first stator yoke 6a and second stator yoke 6b, there is interposed the coil bobbin 7 having the stator coil 8 housed therein. The stator yoke 6, as comprised of the first stator yoke 6a, the second stator yoke 6b and the center yoke 6c, is arranged to cover the surrounding of the annular stator coil 8.

The stator 5 includes the annular stator coil 8 and the stator yoke 6 gripping the stator coil 8 from the two sides in the state to mesh in the comb tooth shape with the pole teeth 6h. These pole teeth 6h include pole teeth 6hr, 6hw and 6hs. The pole teeth 6h of the radially outer side of the stator yoke 6 is faced by a ring magnet 9 of the rotor 4, as described in the following.

All the five magnetic pole pairs of the ring magnet 9 are uniformly magnetized either anisotropically or isotropically. Of the pole teeth 6h of the stator yokes 6 of one pair, on the other hand, only one pole tooth pair (6hw, 6hs) is shifted at an ununiform pole tooth pitch from the uniform position. Specifically, the pitches (or intervals) between the adjoining pole teeth disposed for every stator yoke are uniform in those other than the pole tooth 6hw and the pole tooth 6hs. On the contrary, only the pole tooth 6hw and the pole tooth 6hs are formed to have such ununiform pitches that the pitch is shorter by about 0.9 times than the uniform pitch on the closer side and longer by about 1.1 times of the uniform pitch on the more distant side from the adjoining standard pole tooth 6hr.

As a result, the pole tooth 6hw and the pole tooth 6hs are ununiformly (at a shift angle to increase the detent torque) arranged within the center angle range arranging one magnetic pole pair. As a result, the spaces to be occupied by the pole tooth 6hw and the pole tooth 6hs are different so that the pole teeth have the different widths. Here, the number of pole tooth pairs of the ununiform pitches may be plural.

In Embodiment 1, to bring a desired effect, the uniform pole tooth pair pitches are so shifted by a slip angle to the ununiform pitch position to increase the detent torque.

In the case of this embodiment, the pole tooth pitches between the adjoining magnetic pole pairs of one magnetic pole pair of the stator yoke 6 are increased by several degrees more than the ordinary one so that they are ununiform pole tooth pitches. As a result, one pole tooth 6hw of the paired pole teeth to become the ununiform pole tooth pitch has a larger pole tooth width (i.e., the rotational length) (e.g., about 1.3 times as large as the width of the uniform polar tooth), but the other pole tooth 6hs has a smaller pole tooth width (e.g., about 0.7 times as large as the width of the uniform polar tooth).

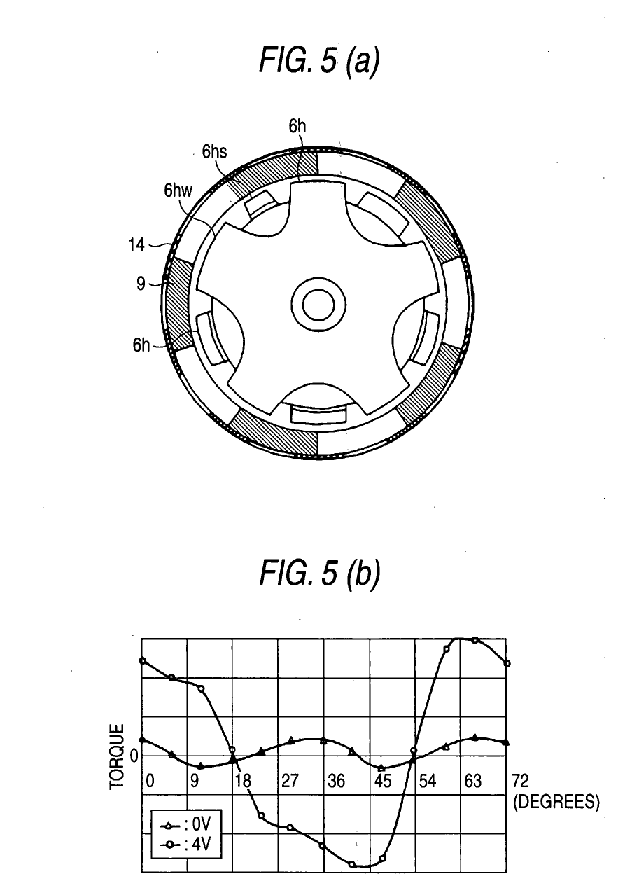

Thus, with reference to the pitch between the paired average adjoining pole teeth, the pole teeth 6h are arranged on a circumference, and only one arbitrary pole tooth pair (6hw, 6hs) is moved by an angle more than the reference angle (i.e., the open angle of the case, in which the pole teeth are uniformly arranged: the angle of a uniform pitch). As a result, the detent torque characteristics are so varied, as shown in FIG. 5(b), for example, so that the starting position adjustment can be made to cause the unidirectional rotation at the starting time.

FIGS. 5(a) and 5(b) are explanatory diagrams of the detent torque characteristics of the vibration generating stepping motor. FIG. 5(a) is an explanatory diagram of the stop position, and FIG. 5(b) plots 0-V (volt) excitation characteristics (or the detent characteristics) and 4-V excitation characteristics. The abscissa indicates a rotation angle, and the ordinate indicates a torque.

The coil bobbin 7 of FIG. 4 is formed of a resin into a C-shaped section and an annular shape in a top plan view (although omitted). An arbitrary wire material can be used for the stator coil 8.

The rotor 4 includes: a shaft 10; a magnet assembly 15 comprised of the ring magnet 9 and a back yoke 14; and a rotor frame 11 having a weight portion 13.

One end of the shaft 10 is provided with a radially constricted protrusion 10a formed to have a step portion. The shaft 10 has a diameter of 0.8 mm, for example. The shaft 10 is inserted into and supported by the bearing 12 in the center yoke 6c.

The rotor frame 11 is formed into a substantial cup shape, which is comprised of: a disc portion 11b having an opening 11a at the center; and a cylindrical portion 11c merging into the circumference of the disc portion 11b.

For conveniences of forming the weight portion partially in the rotor frame 11, the substantial cup shape can form a protruding portion into other than the space shape, which is defined by the disc portion 11b of the uniform thickness and the cylindrical portion 11c, so that the substantial cup shape is used to imply a shape similar to the cup shape. The rotor frame 11 has the weight portion 13 integrally with its portion, as shown in FIG. 4(c).

The rotor frame 11 is made of a metallic material such as iron. The rotor frame 11 has its opening 11a fitted and fixed on the radially constricted protrusion 10a of the shaft 10. At this time, the rotor frame 11 is spaced from the first stator yoke 6a. Moreover, the magnet assembly 15 is mounted on the inner side of the cylindrical portion 11c of the rotor frame 11.

The weight portion 13 of FIG. 4 is made of a metallic material of a high specific gravity and a magnetic material. The weight portion 13 occupies the three-dimensional space, which is defined by a partially annular area S1 of an angular range in the top plan view of FIG. 4(a), and a sectional area S2 in the sectional view of FIG. 4(b). The partially annular area S1 is the partial area from the position on the outer circumference of the disc portion to the position on the radially inner side of a width L1 (i.e., the width, as shown in FIG. 4(b), from the position on the outer circumference of the disc portion 11b of the rotor frame 11 to a position Q1 on the more radially inner side of the radially inner side end of the weight portion 13). This weight portion 13 has its central angle determined for the designing conveniences by the specific gravity or the like of the material, to 120 degrees to 200 degrees in the case of Embodiment 1. The central angle is preferably set to 180 degrees.

Considering the rotor frame 11 as the disc portion 11b of the uniform thickness and the cylindrical portion 11c, the weight portion 13 has the substantial rotor frame 11 and the other inward protruding portion, and is welded to the rotor frame 11.

In connection with a vibration mechanism, in which the rotor frame II having the weight portion 13 is disposed on the shaft 10, the vibration magnitude (centrifugal force) is determined by mrω², for the mass m (Kg) of the weight portion 13, the length r (m) from the center of gravity, and the rotating speed (angular velocity)ω. Since the preferred vibrations are generated at the vibration of about 1 G, a body sensitivity is good at about 10,000 rpm. This makes the outer rotor type having a larger length from the center to the weight portion 13, more advantageous than the inner rotor type. The weight portion 13 can be easily manufactured since it can be formed at an arbitrary position on the circumference of the rotor frame 11. The weight portion 13 is disposed in the cylindrical portion 11c of the rotor frame 11 so that the thickness of the cylindrical portion 11c in the radial direction can be properly designed according to the weight required of the weight portion 13. Moreover, the weight portion 13 has the magnetism so that it has the effect to shield the external magnetic field.

The weight portion 13 is so disposed in a portion of the rotor frame 11 that the center of gravity of the rotor frame 11 may be eccentric to the center of the rotor frame 11. The weight portion 13 is made of a metal such as Fe (iron), Cu (copper), Pb (lead) or W (tungsten), and an alloy containing those metals. The especially preferred material is a magnetic material containing 95 mass % of W (tungsten), 2 mass % of Cu (copper) and 2 mass % of Ni (nickel).

The weight portion 13 can adopt any arbitrary shape, so long as it can substantially compensate the insufficient shape of the rotor frame 11 comprised of the disc portion 11b of the uniform thickness and the cylindrical portion 11c and can support the ring magnet 9.

The cover 3 is made of a nonmagnetic metal such as SUS (stainless steel) 303 to have a C-shaped section, and is formed as a whole into the cup shape having the disc portion 3a and the cylindrical portion 3b erected at a right angle from the circumference of the disc portion 3a. The disc portion 3a is provided, at its plural portions on the end face, with a plurality of protrusions (not-shown), which are to be fixedly soldered or welded to the interface substrate 2. In an example, the cover 3 is formed to have a diameter of 10 mm and a height less than 3 mm.

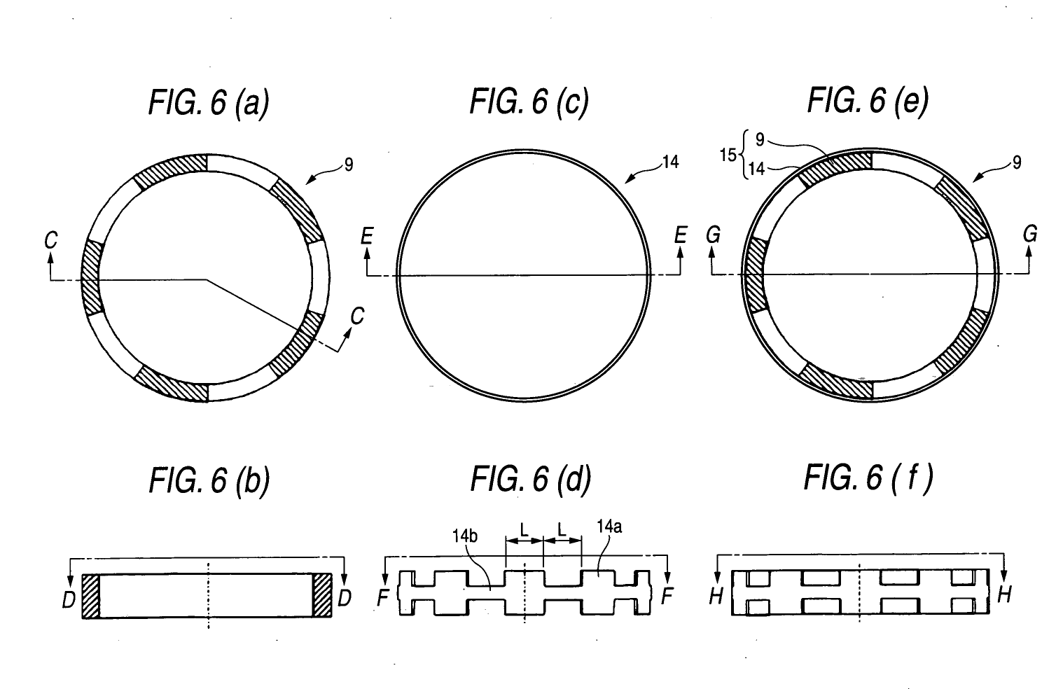

FIGS. 6(a) to 6(f) are assembly diagrams for the magnet assembly of the invention.

FIG. 6(a) is a D-D top plan view of FIG. 6(b) of the ring magnet; FIG. 6(b) is a C-C section of FIG. 6(a) of the ring magnet; FIG. 6(c) is an F-F top plan view of FIG. 6(d) of the back yoke; FIG. 6(d) is an E-E section of FIG. 6(c) of the back yoke; FIG. 6(e) is an H-H top plan view of FIG. 6(f) of the magnet assembly; and FIG. 6(f) is a G-G section of FIG. 6(e) of the magnet assembly.

The magnet assembly 15 includes the ring magnet 9 and the back yoke 14 disposed to contact with the outer circumference of the ring magnet 9.

In the ring magnet 9, five pairs of magnetic poles including the N-poles and the S-poles are annularly arranged in the rotating direction. The ring magnet 9 is made of an arbitrary magnetic material. Preferably, the ring magnet 9 is configured as the ring magnet having a plurality of magnet pairs of the N-poles and the S-poles annularly disposed, and is disposed on the inner side of the rotor frame 11 containing the weight portion 13.

The ring magnet 9 can be comprised of at least one. In this case, the ring magnet 9 is magnetized into multiple poles. The ring magnet 9 is fixed to the rotor frame 11 and the weight portion 13 by means of an adhesive.

The size of the ring magnet 9 is decided according to the torque required.

The ring magnet 9 is magnetized to NS or SN in the rotating direction as the center of the ring magnet 9 is the center of the shaft 10.

In Embodiment 1, all the lengths (or arcuate lengths) of the single magnetic pole of the N-pole or the S-pole of the ring magnet 9 are made equal.

As shown in FIG. 6(c), the back yoke 14 is formed of a magnetic material of a uniform thickness into a ring shape of a uniform width so that it is used to suppress the leakage of the magnetic flux. As shown in FIG. 4(d), the back yoke 14 is comprised of magnetic path forming portions 14a shaped by curving a rectangular thin sheet along an arcuate face, and belt-shaped connecting portions 14b connecting those magnetic path forming portions 14a. These magnetic path forming portions 14a may have any shape, so long as they can connect the N-poles and the S-poles of the ring magnet 9 magnetically. The connecting portions 14b may have any position and any shape, so long as they can connect and hold the magnetic path forming portions 14a. The magnetic path forming portions 14a and the connecting portions 14b may have such lengths in the circumferential direction that the magnetic path forming portions 14a can suppress the leakage of the magnetic flux while giving the remaining length to the connecting portions 14b. It is preferred that the magnetic path forming portions 14a and the connecting portions 14b have lengths at a ratio of 1 to 1.

The back yoke 14 is made of such a magnetic material as may be exemplified by a plate-shaped magnetic metal material, or an adhesive or resin material having magnetic powder melted therein. The adhesive or resin material is applied and adhered, in case it contains the melted magnetic powder, to the corresponding portions. In this case, the connecting portions 14b can be omitted to be applied.

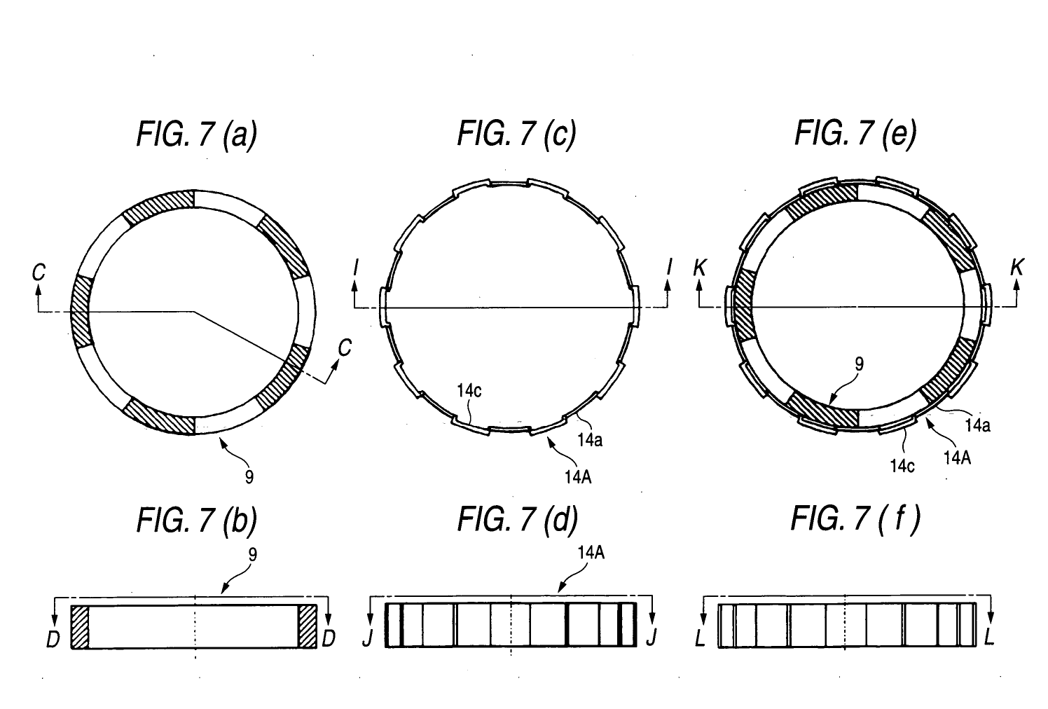

FIGS. 7(a) to 7(f) are assembling diagrams of another embodiment of the back yoke of the invention. FIG. 7(c) is a J-J top plan view showing another embodiment of the back yoke; FIG. 7(d) is an I-I section of FIG. 7(c) showing another embodiment of the back yoke; FIG. 7(e) is an L-L section of FIG. 7(f) showing a magnet assembly; and FIG. 7(f) is a K-K section of FIG. 7(e) showing the magnet assembly. The description is made on the configuration different from that of FIG. 6, but the remaining configuration resorts to the description of FIG. 6 so that its description is omitted.

As shown in FIG. 7(c) and FIG. 7(d), the connecting portions 14b of the back yoke 14 are formed as recesses 14c. The recesses 14c are formed to protrude radially outward from the outer side faces of the magnetic poles so that they may not become the transmission passages for the magnetic flux coming from the magnetic poles of the ring magnet 9. The recesses 14c are formed within the remaining ranges excepting the ranges containing the switching positions of the NS magnetic poles of the rotor magnet 9 and their vicinities. The “vicinities” are relatively determined by the recesses 14c. These recesses 14c are so formed that the magnetic flux between the paired NS magnetic poles may not pass the back yokes on the two sides of the recesses 14c.

The axial width of the connecting portions 14b may be equal to the axial width of the magnetic path forming portions 14a.

### (Drive Circuit)

The vibration generating stepping motor 1 of the invention is controlled according to the speed characteristics of an acceleration, a constant speed and a deceleration. At the acceleration time, the stepping motor 1 is slowly raised up to the constant speed for 0.3 to 0.5 seconds, for example.

The entire size of the motor is very reduced, and the single-phase stepping motor is applied to the vibration generating stepping motor 1. The rotating speed is set to about 10,000 rpm.

When the vibration of about 1 G is applied to the rotating shaft, the rotating speed reaches the maximum. The falling deceleration time period is preferred to be as short as possible.

The acceleration is in the course to the maximum speed (or the constant speed) so that the vibrations by the step drive raise no serious problem. However, the deceleration is in the course to the stop so that the vibrations raise a problem. On the other hand, the excitation time period depends upon the maximum drive current. At the acceleration time period and at the constant-speed time period, for which the vibrations raise no serious problem, therefore, the maximum drive current is set to a high current for the high-speed drive. At the deceleration time, the stepping motor is stopped on the basis of a holding torque.

The single-phase annular stator coil 8 is fed by the drive circuit with an electric current having alternating directions.

A controlling pulse signal is controlled for the aforementioned speed control by the pulse width modulation (PWM), the pulse frequency modulation (PFM) or the pulse amplitude modulation (PAM).

### (Effects of Embodiment 1)

Embodiment 1 can ensure the start without elongating the starting time period and enlarging the starting current.

Since the weight portion 13 is disposed at a portion of the rotor frame 11, the outer rotor type can share the housing spaces for the rotor frame 11 and the weight portion 13. This weight portion 13 can be arranged on the outermost side of the rotating portion so that its radius can be elongated to generate strong vibrations. On the other hand, the stepping motor has no brush so that it needs substantially no maintenance like another brushless motor and can enjoy a long life.

By controlling the rotating speed synchronously with the input pulses, moreover, the vibration magnitude can be linearly adjusted, and the stopping time period can be shortened.

Because of the single phase drive, a drive pulse current having alternately changing directions is inputted to the single-phase stator coil 8 wound on the stator yoke 6. Because of the single phase, the coil reduces the occupied space and the thickness. Moreover, the control circuit is based on the current inverting circuit so that it can be simply configured.

The pole teeth 6h of the single-phase stator yoke assembly are so arranged by combining the pole teeth 6hr, 6hw and 6hs of the three kinds of the different heights and widths and of the different areas as to increase the detent torque. As a result, it is possible to hold the stop position and to stabilize the starting characteristics.

All the five magnetic pole pairs of the ring magnet 9 comprising either anisotropic magnet or isotropic magnet are uniformly magnetized. Of the pole teeth 6h of the stator yokes 6 of one pair, on the other hand, only one pole tooth pair (6hw, 6hs) is shifted at an ununiform pole tooth pitch from the uniform position. Specifically, the pitches (or intervals) between the adjoining pole teeth disposed for every stator yoke are uniform in those other than the pole tooth 6hw and the pole tooth 6hs. On the contrary, only the pole tooth 6hw and the pole tooth 6hs are formed to have such ununiform pitches that the pitch is shorter by about 0.9 times than the uniform pitch on the closer side and longer by about 1.1 times of the uniform pitch on the more distant side from the adjoining standard pole teeth 6hr and 6hr.

As a result, the pole teeth 6hw and 6hs are in an imbalanced manner (or not-equidistantly) within the center angle range for one magnetic pole pair. As a result, the occupied spaces are made different to make the widths of the pole teeth different. Here, the pole teeth of the ununiform pitches may also be provided in plurality.

In the case of this embodiment, the pole tooth pitches between the adjoining magnetic pole pairs (6hr) of one magnetic pole pair (i.e., the pole tooth 6hw and the pole tooth 6hs) of the stator yoke 6 are increased by several degrees more than the ordinary one so that they are ununiform pole tooth pitches. As a result, one pole tooth 6hw of the paired pole teeth to become the ununiform pole tooth pitch has a larger pole tooth width (i.e., the rotational length) (e.g., about 1.3 times as large as the width of the uniform pole tooth), but the other pole tooth 6hs has a smaller pole tooth width (e.g., about 0.7 times as large as the width of the uniform pole tooth).

Thus, with reference to the pitch between the paired average adjoining pole teeth, the pole teeth are arranged on a circumference, and only one arbitrary pole tooth pair is shifted by an angle more than the reference angle. As a result, the detent torque characteristics are so varied, as shown in FIG. 5(b), for example, so that the starting position can be adjusted to cause the unidirectional rotation at the starting time. The change of the configuration thus far described in combination at the function unit can be performed on the basis of the intended problem.

1. A vibration generating stepping motor, comprising a single-phase stator yoke assembly comprising a first stator yoke and a second stator yoke,
the first stator yoke comprising first pole teeth and second pole teeth, the first and second pole teeth having different areas of respective outermost side faces in a radial direction of the stepping motor,
the second stator yoke comprising the first pole teeth and third pole teeth having an area of an outermost side surface in the radial direction, the area of the third pole teeth being different from those of the first and second pole teeth, and
the first stator yoke and the second stator yoke are arranged so that the second pole teeth and the third pole teeth are combined so as to shift hold positions to increase a detent torque of the stepping motor.

2. A vibration generating stepping motor according to claim 1, wherein the areas of the first to third pole teeth are set by varying at least one of a height in a axial direction and a width in a rotating direction of each of the first to third pole teeth.

3. A vibration generating stepping motor according to claim 1, wherein each of the outermost side faces in the radial direction of the first to third pole teeth has a trapezoidal shape.

4. A vibration generating stepping motor according to claim 3, wherein an angle of inclination of the trapezoidal shape is common in the first to third pole teeth.

5. A vibration generating stepping motor according to claim 1, wherein the second pole teeth and the third pole teeth are provided in combination by one or more arbitrary n-pairs thereof.

6. A vibration generating stepping motor according to claim 1, wherein
the first pole teeth are trapezoidal standard pole teeth,
one of the second pole teeth and the third pole teeth are trapezoidal wider pole teeth, the trapezoidal wider pole teeth being as high in the axial direction as the standard pole teeth, wider in the rotating direction than the standard pole teeth, and equal in the angle of inclination of an oblique side to the standard pole teeth,
the other of the second pole teeth and the third pole teeth are trapezoidal narrower and lower pole teeth, the narrower and lower pole teeth being lower in the axial direction than the standard pole teeth, narrower in the rotating direction than the standard pole teeth, and equal in the angle of inclination of an oblique side to the standard pole teeth, and
the first to third pole teeth are arranged to mesh in a comb tooth shape.

7. A vibration generating stepping motor according to claim 1 wherein a rotor magnet is disposed on a rotor facing the single-phase stator yoke assembly, and the rotor magnet is a ring magnet magnetized at different magnetic poles alternately in the rotating direction.

8. A vibration generating stepping motor according to claim 7, wherein the first pole teeth are arranged to have centers thereof conforming to switching positions of NS magnetic poles of the rotor magnet, and
the second pole teeth and the third pole teeth are individually arranged to have centers thereof shifted from the switching positions of the NS magnetic poles by an shift angle to increase the detent torque.

9. A vibration generating stepping motor according to claim 7, wherein the ring magnet has a ring-shaped back yoke.

10. A vibration generating stepping motor according to claim 9, wherein the back yoke has a recess within a remaining range excepting a range containing the switching
positions of the NS magnetic poles of the rotor magnet and a vicinity thereof.
